(19) United States
(12) Patent Application Publication
(10) Pub. No.: US 2006/0127854 A1
(43) Pub. Date: Jun. 15, 2006

(54) Image based dentition record digitization

(76) Inventor: Huafeng Wen, Redwood City, CA (US)

Correspondence Address: MORRISON & FOERSTER LLP, 755 PAGE MILL RD, PALO ALTO, CA, 94304-1018, US

(21) Appl. No.: 11/013,153

(22) Filed: Dec. 14, 2004

(51) Int. Cl. A61C 11/00

(52) U.S. Cl. 433/213

(57) ABSTRACT

Systems and methods are disclosed for generating a 3D model of an object using one or more cameras by: calibrating each camera; establishing a coordinate system and environment for the one or more cameras; registering one or more fiducials on the object; and capturing one or more images and constructing a 3D model from images.

### BACKGROUND

Photogrammetry is the term used to describe the technique of measuring objects (2D or 3D) from photogrammes. Photogrammes is a more generic description than photographs. Photogrammes includes photographs and also includes imagery stored electronically on tape or video or CCD cameras or radiation sensors such as scanners.

As discussed in U.S. Pat. No. 6,757,445, in traditional digital orthophoto processes, digital imagery data typically are acquired by scanning a series of frames of aerial photographs which provide coverage of a geographically extended project area. Alternatively, the digital imagery data can be derived from satellite data and other sources. Then, the image data are processed on a frame by frame basis for each picture element, or pixel, using rigorous photogrammetric equations on a computer. Locations on the ground with known coordinates or direct measurement of camera position are used to establish a coordinate reference frame in which the calculations are performed.

During conventional orthophoto production processes, a DEM, or digital elevation model (DEM), is derived from the same digital imagery used in subsequent orthorectification, and this DEM has to be stored in one and the same computer file. Then, the imagery data for each frame is orthorectified using elevation data obtained from the DEM to remove image displacements caused by the topography (“relief displacements”). For many conventional processes, the steps of measurement are performed with the imagery data for each frame or for a pair of two frames having a 60% forward overlap. In traditional image processing systems, the measurement process is carried out primarily on the digital imagery accessed in pairs of overlapping frames known as a “stereomodel”. Subsequent photogrammetric calculations often are carried out on the digital imagery on a stereomodel basis. Orthorectification is carried out on the digital imagery on a frame by frame basis. These processes are time consuming and costly. For example, using traditional methods with high process overhead and logistical complexity, it can take days to process a custom digital orthophoto once the imagery has been collected. After orthorectification of the individual frames, the orthorectified images are combined into a single composite image during a mosaicking step.

### SUMMARY

Systems and methods are disclosed for generating a 3D model of an object using one or more cameras by: calibrating each camera; establishing a coordinate system and environment for the one or more cameras; registering one or more fiducials on the object; and capturing one or more images and constructing a 3D model from images.

The resulting model can be used for measurement of 3 D geometry for teeth/gingival/face/jaw; measurement of position, orientation and size of object(teeth/gingival/face/jaw); determine the type of malocclusion for treatment; recognition of tooth features; recognition of gingiva feature; extraction of teeth from jaw scans; registration with marks or sparkles to identify features of interest; facial profile analysis; and filling in gaps in 3 D models from photogrammetry using preacquired models based on prior information about teeth/jaw/face, among others. The foregoing can be used to create a facial/orthodontic model .

Advantages of the system include one or more of the following. The system enables patients/doctors/dentists to be able to look at photorealistic rendering of the patient as they would appear to be after treatment. In case of orthodontics for example, a patient will be able to see what kind of smile he or she would have after treatment. The system may use 3D morphing, which is an improvement over 2 D morphing since true 3D models are generated for all intermediate models. The resulting 3D intermediate object can be processed with an environmental model such as lighting, color, texture etc to realistically render the intermediate stage. Camera viewpoints can be changed and the 3D models can render the intermediate object from any angle. The system permits the user to generate any desired 3D view, if provided with a small number of appropriately chosen starting images. The system avoids the need for 3D shape modeling. System performance is enhanced because the morphing process requires less memory space, disk space and processing power than the 3D shape modeling process. The resulting 3D images are lifelike and visually convincing because they are derived from images and not from geometric models. The system thus provides a powerful and lasting impression, engages audiences and creates a sense of reality and credibility.

Other aspects and advantages of the invention will become apparent from the following detailed description and accompanying drawings which illustrate, by way of example, the principles of the invention.

### BRIEF DESCRIPTION OF THE DRAWINGS

The following detailed description of the embodiments of the invention will be more readily understood in conjunction with the accompanying drawings, in which:

FIG. 1 shows an exemplary process for capturing 3D dental data.

FIG. 2 shows an exemplary tooth having a plurality of markers or fiducials positioned thereon.

FIG. 3 shows an exemplary multi-camera set up for dental photogrammetry.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DESCRIPTION

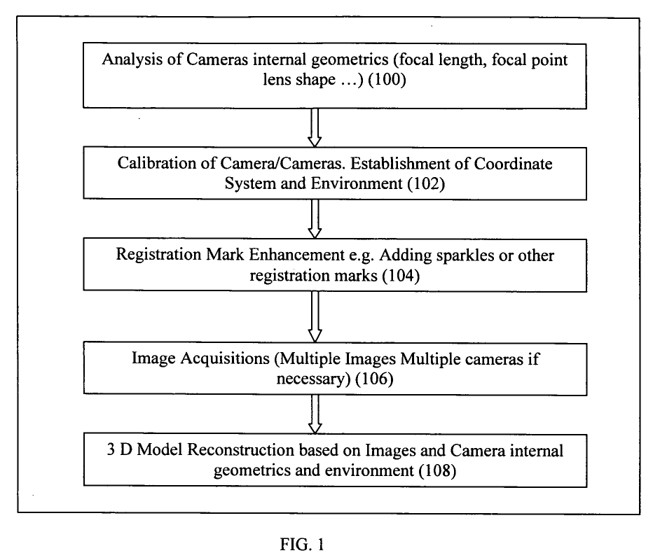

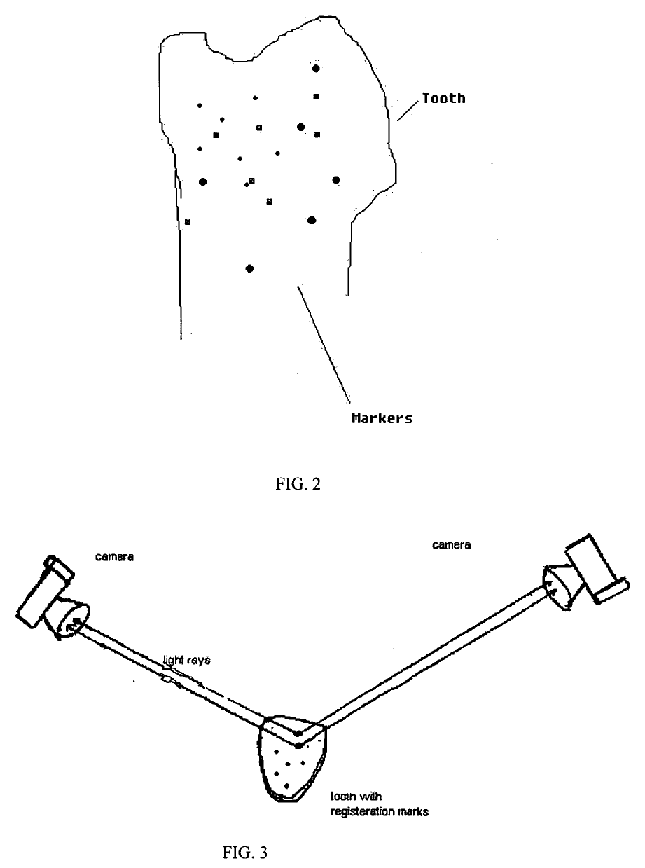

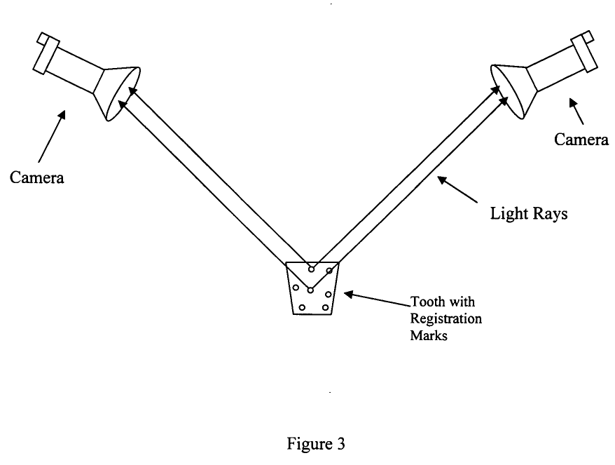

FIG. 1 shows an exemplary process for capturing 3D dental data using photogrammetry, while FIG. 2 shows an exemplary tooth having a plurality of markers or fiducials positioned thereon and FIG. 3 shows an exemplary multi-camera set up for the dental photogrammetry reconstruction. Multiple camera shots are used to generate the face geometry to produce a true 3 D model of the face and teeth.

Turning now to FIG. 1, the process first characterizes cameras internal geometries such as focal length, focal point, and lens shape, among others. (100). Next, the process calibrates each camera and establishes a coordinate system and determines the photo environment such as lighting, among others (102). Next, the process can add Registration Mark Enhancements such as adding sparkles or other registration marks (104). The image acquisitions (Multiple Images Multiple cameras if necessary) are performed by the cameras (106), and a 3 D Model Reconstruction is done based on Images and Camera internal geometrics and the environment (108).

The analysis of camera internal geometrics characterizes properties of device use for collection the data. The camera lens distorts the rays coming from the object to the recording medium. In order to reconstruct the ray properly, the internal features/geometry of the camera need to be specified so that corrections to the images gathered can be applied to account for distortions of the image. Information about the internal geometrics of camera such as the focal length, focal point, lens shape, among othes, are used for making adjustments to the photogrammetric data.

The system is then precisely calibrated to get accurate 3D information from the cameras. This is done by photographing objects with precisely known measurements and structure. A Coordinate System and Environment for photogrammetry is established in a similar fashion.

Registration Mark Enhancement can be done by adding sparkles or other registration marks such as shapes with known and easy to distinguish colors and shapes to mark areas of interest. This gives distinguishable feature points for photogrammetry. As an example, points are marked on the cusp of teeth or on the FACC point or on the gingiva line to enable subsequent identification of these features and separation of the gingiva from the teeth.

The Image Acquisition (Multiple Images Multiple cameras if necessary) is done in the following way.

1. Multiple Cameras. Multiple cameras take shots from various angles. At least two pictures are needed. With take more pictures, this takes care of partial object occlusion and can also be use for self calibration of the system from the pictures of the objects themselves.

2. Moving Camera: Pictures are taken from a moving camera from various angles. By taking many pictures of a small area from various angles allows very high resolution 3 D models.

3. Combination of Multiple Cameras and moving cameras.

The 3D Model Reconstruction can be done based on Images and Camera internal geometrics and environment. Triangulation is used to compute the actual 3D model for the object. This is done by intersecting the rays with high precision and accounting for the camera internal geometries. The result is the coordinate of the desired point. The identified structures can be used to generate 3D models that can be viewed using 3D CAD tools. In one embodiment, a 3D geometric model in the form of a triangular surface mesh is generated. In another implementation, the model is in voxels and a marching cubes algorithm is applied to convert the voxels into a mesh, which can undergo a smoothing operation to reduce the jaggedness on the surfaces of the 3D model caused by the marching cubes conversion. One smoothing operation moves individual triangle vertices to positions representing the averages of connected neighborhood vertices to reduce the angles between triangles in the mesh. Another optional step is the application of a decimation operation to the smoothed mesh to eliminate data points, which improves processing speed. After the smoothing and decimation operation have been performed, an error value is calculated based on the differences between the resulting mesh and the original mesh or the original data, and the error is compared to an acceptable threshold value. The smoothing and decimation operations are applied to the mesh once again if the error does not exceed the acceptable value. The last set of mesh data that satisfies the threshold is stored as the 3D model. The triangles form a connected graph. In this context, two nodes in a graph are connected if there is a sequence of edges that forms a path from one node to the other (ignoring the direction of the edges). Thus defined, connectivity is an equivalence relation on a graph: if triangle A is connected to triangle B and triangle B is connected to triangle C, then triangle A is connected to triangle C. A set of connected nodes is then called a patch. A graph is fully connected if it consists of a single patch. The mesh model can also be simplified by removing unwanted or unnecessary sections of the model to increase data processing speed and enhance the visual display. Unnecessary sections include those not needed for creation of the tooth repositioning appliance. The removal of these unwanted sections reduces the complexity and size of the digital data set, thus accelerating manipulations of the data set and other operations. The system deletes all of the triangles within the box and clips all triangles that cross the border of the box. This requires generating new vertices on the border of the box. The holes created in the model at the faces of the box are retriangulated and closed using the newly created vertices. The resulting mesh can be viewed and/or manipulated using a number of conventional CAD tools.

In an embodiment, the system collects the following data:

1. Photogrammetry of the patients head/face. This is the how the patient currently looks before treatment including the soft tissue of the face.

2. Photogrammetry for of the jaw and teeth of the patient. This is how the jaw and teeth are initially oriented prior to the treatment.

3. X-Rays for Bone and tissue information.

4. Information about the environment to separate the color pigment information from the shading and shadow information of the patient.

The patient's color pigment can be obtained from shadow/shading in the initial photo. The initial environmental information is generated by pre-positioning lights with known coordinates as inputs to the system. Alternatively, lighting from many angles can be used so that there are no shadows and lighting can be incorporated into the 3 D environment.

The data is combined to create a complete 3D model of the patients face using the Patient's 3D Geometry, Texture, Environment Shading and Shadows. This is a true Hierarchy model with bone, teeth, gingival, joint information, muscles, soft tissue, and skin. All missing data such as internal muscle is added using our prior knowledge of facial models.

One embodiment measures 3 D geometry for the teeth/gingival/face/jaw. Photogrammetry is used for scanning and developing a 3D Model for the object of interest. For teeth/jaw or face model various methods can be used to achieve this. One approach is to directly get pictures of the object. The other approach as in model of teeth and jaw is to get a mold of the teeth and use photogrammetry on the mold to get the tooth/jaw model.

Another embodiment measures position, orientation and size of object (teeth/gingival/face/jaw). Photogrammetry is used for not just the structure of the object but also for position and orientation and size of the object. As an example, in one method teeth is removed from a jaw mold model and individually use photogrammetry on each tooth to get a 3D model of each tooth. Furthermore we use photogrammetry on all the teeth together to get the position and orientation of each tooth relative to each other as would be placed in a jaw. The jaw can then be reconstructed from the separated teeth.

Another embodiment determines the type of malocclusion for treatment. Photogrammetry is used to get the relative position of the upper jaw relative to the lower jaw. The type of malocclusion can then be determined for treatment.

Another embodiment recognizes tooth features from the photogrammetry. As an example we recognize the various cusps on the molar teeth. Furthermore we use these and other features for the identifying each tooth in 3d model.

Similarly, in another embodiment, photogrammetry is used to recognize features on the gingiva. As an example special registration marks are used to identify various parts of gingiva, particularly the gingival lines so that the gingival can be separated from the rest of the jaw model.

In yet another embodiment, teeth are extracted from jaw scans. Photogrammetry is used to separate teeth from the rest of the jaw model by recognizing the gingival lines and the inter-proximal area of the teeth. Special registration marks identify the inter-proximal areas between teeth and also mark the gingival lines using other registration marks. This allows the individual teeth to be separated from the rest of the jaw model.

In another embodiment, registration marks or sparkles to identify features of interest. Special registration marks can be used for marking any other areas or features of interest in the object of interest.

In another embodiment, facial profile analysis is done by applying photo grammetry to develope 3 D model of the face and internals of the head. The face and jaws are separately made into 3 D model using photogrammetry and combined using prior knowledge of these models to fill in the missing pieces and come up with a hierarchical model of the head, face, jaw, gingiva, teeth, bones, muscles, facial tissues.

Gaps in the 3 D models derived from photogrammetry can be filled in using a database with models and prior information about teeth/jaw/face, among others. The facial/orthodontic database of prior knowledge is used to fill in the missing pieces such as muscle structure in the model. The database can also be used for filling in any other missing data with good estimates of what the missing part should look like.

Certain treatment design information such as how the teeth move during the orthodontic treatment and changes in the tooth movement can be used with the database of pre-characterized faces and teeth to determine how changes in a particular tooth position results in changes in the jaw and facial model. Since all data at this stage is 3 D data, the system can compute the impact of any tooth movement using true 3 D morphing of the facial model based on the prior knowledge of teeth and facial bone and tissue. In this manner, movements in the jaw/teeth result in changes to the 3D model of the teeth and face. Techniques such as collision computation between the jaw and the facial bone and tissue are used to calculate deformations on the face. The information is then combined with curves and surfaces based smoothing algorithms specialized for the 3D models and the database containing prior knowledge of faces to simulate the changes to the overall face due to localized changes in tooth position. The gradual changes in the teeth/face can be visualized and computed using true 3D morphing.

In one implementation of the generation of 3 D Face Model for the patient and extraction of environment, a true hierarchical face model with teeth, bone, joints, gingiva, muscle, soft tissue and skin. Changes in position/shape of one level of the hierarchy changes all dependent levels in the hierarchy. As an example a modification in the jaw bone will impact the muscle, soft tissue and skin. This includes changes in the gingiva.

The process extrapolates missing data using prior knowledge on the particular organ. For example, for missing data on a particular tooth, the system consults a database to estimate expected data for the tooth. For missing facial data, the system can check with a soft tissue database to estimate the muscle and internal tissue which are extrapolated.

The system also estimate the behavior of the organ based on its geometry and other model of the organ. An expert system computes the model of face and how the face should change if pressure is applied by moved teeth. In this manner, the impact of teeth movement on the face is determined. Changes in the gingival can also be determined using this model.

In one implementation, geometry subdivision and tessellation are used. Based on changes in the face caused by changes in teeth position, at times it is required to sub divide the soft face tissue geometry for a more detailed/smooth rendering. At other times the level of detail needs to be reduced. The model uses prior information to achieve this. True 3 D morphing connects the initial and modified geometry for showing gradual changes in the face model.

In certain applications that need the external 3 D model for the face and the 3 D model for the jaw/teeth as well as internal model such as. the inner side of the facial tissue, and muscle tissue, hole filling and hidden geometry prediction operations are performed on the organ. The internal information is required in these applications to model the impact of changes at various level of model hierarchy on the overall model. As an example, teeth movement can impact facial soft tissue or bone movements. Hence, jaw movements can impact the muscles and the face. A database containing prior knowledge can be used for generating the internal model information.

In one implementation, gingiva prediction is done. The model recomputes the gingivas geometry based on changes in other parts of the facial model to determine how teeth movement impacts the gingiva.

In another implementation, a texture based 3D geometry reconstruction is done. The actual face color/pigment is stored as a texture. Since different parts of the facial skin can have different colorations, texture maps store colors corresponding to each position on the face 3D model.

An alternate to scanning the model is to have a 2D picture of patient. The process then maps point(s) on the 2D picture to a 3D model using prior information on typical sets of heads 3D (for example by applying texture mapping). The simulated 3D head is used for making the final facial model.

In an embodiment that uses ‘laser marking’, a minute amount of material on the surface of the tooth model is removed and colored. This removal is not visible after the object has been enameled. In this process a spot shaped indentation is produced on the surface of the material. Another method of laser marking is called ‘Center Marking’. In this process a spot shaped indentation is produced on the surface of the object. Center marking can be ‘circular center marking’ or ‘dot point marking’.

In the laser marking embodiment, small features are marked on the crown surface of the tooth model. After that, the teeth are moved, and each individual tooth is superimposed on top of each other to determine the tooth movement. The wax setup is done and then the system marks one or more points using a laser. Pictures of the jaw are taken from different angles. After that, the next stage is produced and the same procedure is repeated. Stages x and x+1 pictures are overlaid. The change of the laser points reflects the exact amount of tooth movement.

In yet another embodiment called sparkling, marking or reflective markers are placed on the body or object to be motion tracked. The sparkles or reflective objects can be placed on the body/object to be motion tracked in a strategic or organized manner so that reference points can be created from the original model to the models of the later stages. In this embodiment, the wax setup is done and the teeth models are marked with sparkles. Alternatively, the system marks or paints the surface of the crown model with sparkles. Pictures of the jaw are taken from different angles. Computer software determines and saves those pictures. After that, the teeth models are moved. Each individual tooth is mounted on top of the other and tooth movement can be determined. Then the next stage is performed, and the same procedure is repeated.

In another embodiment that uses freehand without mechanical attachment or any restrictions, the wax setup operation is done in freehand without the help of any mechanical or electronic systems. Tooth movement is determined manually with scales and/or rules and these measurements are entered into the system.

An alternative is to use a wax set up in which the tooth abutments are placed in a base which has wax in it. One method is to use robots and clamps to set the teeth at each stage. Another method uses a clamping base plate. i.e. a plate on which teeth can be attached on specific positions. Teeth are setup at each stage using this process. Measurement tools such as the micro scribe are used to get the tooth movements which can be used later by the universal joint device to specify the position of the teeth.

In another embodiment, the FACC lines are marked. Movement is determined by non mechanical method or by a laser pointer. The distance and angle of the FACC line reflects the difference between the initial position and the next position on which the FAC line lies.

In a real time embodiment, the teeth movements are checked in real time. The cut teeth are placed in a container attached to motion sensors. These sensors track the motion of the teeth models in real time. The motion can be done with freehand or with a suitably controlled robot. Stage x and stage x+1 pictures are overlaid, and the change of the points reflects the exact amount of movement.

The system has been particularly shown and described with respect to certain preferred embodiments and specific features thereof. However, it should be noted that the above described embodiments are intended to describe the principles of the invention, not limit its scope. Therefore, as is readily apparent to those of ordinary skill in the art, various changes and modifications in form and detail may be made without departing from the spirit and scope of the invention as set forth in the appended claims. Other embodiments and variations to the depicted embodiments will be apparent to those skilled in the art and may be made without departing from the spirit and scope of the invention as defined in the following claims.

In particular, it is contemplated by the inventor that the principles of the present invention can be practiced to track the orientation of teeth as well as other articulated rigid bodies including, but not limited to prosthetic devices, robot arms, moving automated systems, and living bodies. Further, reference in the claims to an element in the singular is not intended to mean “one and only one” unless explicitly stated, but rather, “one or more”. Furthermore, the embodiments illustratively disclosed herein can be practiced without any element which is not specifically disclosed herein. For example, the system can also be used for other medical, surgical simulation systems. Thus, for plastic surgery applications, the system can show the before and after results of the procedure. In tooth whitening applications, given an initial tooth color and given a target tooth color, the tooth surface color can be morphed to show changes in the tooth color and the impact on the patient face. The system can also be used to perform lip sync. The system can also perform face detection: depending of facial expression, a person can have multiple expressions on their face at different times and the model can simulate multiple expressions based on prior information and the multiple expressions can be compared to a scanned face for face detection. The system can also be applied to show wound healing on the face through progressive morphing. Additionally, a growth model based on a database of prior organ growth information to predict how an organ would be expected to grow and the growth can be visualized using morphing. For example, a hair growth model can show a person his or her expected appearance three to six months from the day of the haircut using one or more hair models.

The techniques described here may be implemented in hardware or software, or a combination of the two. Preferably, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices.

One such computer system includes a CPU, a RAM, a ROM and an I/O controller coupled by a CPU bus. The I/O controller is also coupled by an I/O bus to input devices such as a keyboard and a mouse, and output devices such as a monitor. The I/O controller also drives an I/O interface which in turn controls a removable disk drive such as a floppy disk, among others.

Variations are within the scope of the following claims. For example, instead of using a mouse as the input devices to the computer system, a pressure-sensitive pen or tablet may be used to generate the cursor position information. Moreover, each program is preferably implemented in a high level procedural or object-oriented programming language to communicate with a computer system. However, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

While the invention has been shown and described with reference to an embodiment thereof, those skilled in the art will understand that the above and other changes in form and detail may be made without departing from the spirit and scope of the following claims.

1. A method for generating a 3D model of an object using one or more cameras, comprising:
calibrating each camera;
establishing a coordinate system and environment for the one or more cameras;
registering one or more fiducials on the object; and
capturing one or more images and constructing a 3D model from images.

2. The method of claim 1, wherein the model is used for one of the following: measurement of 3 D geometry for teeth/gingival/face/jaw; measurement of position, orientation and size of teeth/gingival/face/jaw; determination of the type of malocclusion for treatment; recognition of tooth features; recognition of gingiva feature; extraction of teeth from jaw scans; registration with marks or sparkles to identify features of interest; facial profile analysis; filling in gaps in 3 D models from photogrammetry using preacquired models based on prior information about teeth/jaw/face, and creating a facial/orthodontic model.

3. The method of claim 1, comprising:
a. receiving an initial 3D model for the patient;
b. determining a target 3D model; and
c. generating one or more intermediate 3D models.

4. The method of claim 1, comprising extracting environment information from the model.

5. The method of claim 1, comprising rendering one or more images of the model.

6. The method of claim 1, wherein the model is represented using one of: polyhedrons and voxels.

7. The method of claim 1, wherein the model is a patient model

8. The method of claim 7, comprising generating a virtual treatment for the patient and generating a post-treatment 3D model.

9. The method of claim 1, comprising geometry subdividing and tessellating the model.

10. The method of claim 1, comprising:
identifying one or more common features on the tooth model;
detecting the position of the common features on the tooth model at the first position;
detecting the position of the common features on the tooth model at the second position; and
determining a difference between the position of each common feature at the first and second positions.

11. A system for generating a 3D model of an object, comprising:
one or more calibrated cameras;
means for establishing a coordinate system and environment for the one or more cameras;
means for registering one or more fiducials on the object; and
means for capturing one or more images and constructing a 3D model from images.

12. The system of claim 11, wherein the model is used for one of the following: measurement of 3 D geometry for teeth/gingival/face/jaw; measurement of position, orientation and size of teeth/gingival/face/jaw; determination of the type of malocclusion for treatment; recognition of tooth features; recognition of gingiva feature; extraction of teeth from jaw scans; registration with marks or sparkles to identify features of interest; facial profile analysis; filling in gaps in 3 D models from photogrammetry using preacquired models based on prior information about teeth/jaw/face, and creating a facial/orthodontic model.

13. The system of claim 11, comprising means for:
a. receiving an initial 3D model for the patient;
b. determining a target 3D model; and
c. generating one or more intermediate 3D models.

14. The system of claim 11, comprising means for extracting environment information from the model.

15. The system of claim 11, comprising means for rendering one or more images of the model.

16. The system of claim 11, wherein the model is represented using one of: polyhedrons and voxels.

17. The system of claim 11, wherein the model is a patient model

18. The system of claim 17, comprising means for generating a virtual treatment for the patient and generating a post-treatment 3D model.

19. The system of claim 11, comprising means for geometry subdividing and tessellating the model.

20. The system of claim 11, comprising means for:
identifying one or more common features on the tooth model;
detecting the position of the common features on the tooth model at the first position;
detecting the position of the common features on the tooth model at the second position; and
determining a difference between the position of each common feature at the first and second positions.
